(19) United States
(12) Patent Application Publication
(10) Pub. No.: US 2018/0197490 A1
(43) Pub. Date: Jul. 12, 2018

(54) METHOD OF DRIVING A LIQUID CRYSTAL DISPLAY APPARATUS AND LIQUID CRYSTAL DISPLAY APPARATUS

(71) Applicant: WUHAN CHINA STAR OPTOELECTRONICS TECHNOLOGY CO., LTD, Wuhan, Hubei (CN)

(72) Inventors: Chunpeng GUO, Shenzhen, Guangdong (CN); Gonghua ZOU, Shenzhen, Guangdong (CN)

(73) Assignee: Wuhan China Star Optoelectronics Technology Co., Ltd., Wuhan, Hubei (CN)

(21) Appl. No.: 15/117,442

(22) PCT Filed: Jul. 11, 2016
(86) PCT No.: PCT/CN2016/089612

§ 371 Date: Aug. 8, 2016

(30) Foreign Application Priority Data
Jun. 7, 2016 (CN) 201610405841X

(51) Int. Cl. G09G 3/36

(52) U.S. Cl. CPC G09G 3/3607; G09G 2320/0276

(57) ABSTRACT

The present application discloses a method of driving a liquid crystal display apparatus and a liquid crystal display apparatus, the driving method includes: obtaining at least two Gamma values of the corresponding display areas of the liquid crystal display apparatus respectively, wherein the at least two Gamma values of the corresponding display areas respectively are not the same, and the conditions of the backlight of the at least two display areas is different; and determining the driving voltage of the pixels in the at least two display areas according to the corresponding Gamma values respectively of the at least two display areas and the gray scale values to be displayed of the at least two display areas. It can effectively improve the uneven display image problem of the liquid crystal display apparatus caused by the light emitted from the backlight, and raise the performance of the liquid crystal display apparatus.

### FIELD OF THE INVENTION

The present application relates to a display technology field, and more particularly to method of driving a liquid crystal display apparatus and a liquid crystal display apparatus.

### BACKGROUND OF THE INVENTION

With the development of technology, different types of intelligent devices and electronic products having a liquid crystal display device become an integral part of people's lives, but whether it is large or small-sized liquid crystal display device, the backlight light source is required, the conventional backlight source of the liquid crystal display device generally used is an area light source backlight module.

The area light source is a planar light source, in accordance with the form, mainly includes a compact fluorescent lamp, a cold light sheet, light emitting diodes, wherein, because of the advantages of the light emitting diodes such as the low working voltage, low power consumption and long life, are widely used as a backlight source of the backlight module in the liquid crystal display device.

Taking LED backlight source as an example to illustrate, the backlight module includes a diffusion sheet, a prism sheet, a light guide plate, a reflective layer and a LED backlight source, wherein the reflective layer is formed under the light guide plate, the prism sheet is located above the light guide plate, the diffusion sheet is located above the prism sheet, the LED backlight source is disposed in one side of the light guide plate. The light generated by the LED light source is incident into a side surface of the light guide plate, and then have the uniform light process by the surface of the light guide plate, the light reflected by the reflective layer, and finally produce the area light source through the prism sheet and the diffusion sheet.

However, because the LED backlight source is generally formed by disposing a plurality of LED in interval on the printed circuit board, when the number of LED is less, and located on the side of the light guide plate, the divergence angle of the LED light source is limited, dark areas of the region of the light guide plate close to the LED light source are appeared. While in some other places, because of the superimposed of the adjacent LED, bright areas are appeared, reducing the uniformity of the emission light of the light guide plate, and due to the light emitted from the light-emitting diode is perspective and in wide angle but not parallel, resulting in the incident light into the light guide plate is not uniform, and finally resulting in uneven display image of the liquid crystal display device.

### SUMMARY OF THE INVENTION

The present application to mainly solve the technology problem is to provide a method of driving a liquid crystal display apparatus and a liquid crystal display apparatus, it can effectively improve the uneven display image problem of the liquid crystal display apparatus caused by the light emitted from the backlight, and raise the performance of the liquid crystal display apparatus.

In order to solve the technology problem above, the technology approach adapted in the present application is: providing a method of driving a liquid crystal display apparatus, the driving method including:

obtaining a first Gamma value corresponding to a first display area of the liquid crystal display apparatus, a second Gamma value corresponding to a second display area, and a third Gamma value corresponding to a third display area; wherein the backlight luminance corresponding to the first display area, the second display area and the third display area are decreased sequentially; the first Gamma value, the second value Gamma, and the third Gamma value are decreased sequentially;

according to the corresponding Gamma values respectively of the at least two display areas and the gray scale values to be displayed of the at least two display areas, to determine the driving voltage of the pixels in the at least two display areas; and driving by the driving voltage and turning on the pixels of the at least two display areas.

Wherein the first Gamma value is 3, the second Gamma value is 2.2, and the third Gamma value is 1.

Wherein before the steps of obtaining a first Gamma value corresponding to a first display area of the liquid crystal display apparatus, a second Gamma value corresponding to a second display area, and a third Gamma value corresponding to a third display area further including:

dividing the liquid crystal display apparatus into three display areas according to the conditions of the backlight of the liquid crystal display apparatus.

Wherein the Gamma values corresponding to different display areas is stored in the different registers of the liquid crystal display apparatus respectively.

In order to solve the technology problem above, the technology approach adapted in the present application is: providing a method of driving a liquid crystal display apparatus, the driving method including:

obtaining at least two Gamma values of the corresponding display areas of the liquid crystal display apparatus respectively, wherein the at least two Gamma values of the corresponding display areas respectively are not the same, and the conditions of the backlight of the at least two display areas is different; and

determining the driving voltage of the pixels in the at least two display areas according to the corresponding Gamma values respectively of the at least two display areas and the gray scale values to be displayed of the at least two display areas.

Wherein the liquid crystal display apparatus including a first display area, a second display area and a third display area with a descending luminance sequentially;

the steps of obtaining at least two Gamma values of the corresponding display areas of the liquid crystal display apparatus respectively specific including:

obtaining a first Gamma value corresponding to the first display area, a second Gamma value corresponding to the second display area, and a third Gamma value corresponding to the third display area; wherein the first Gamma value, the second value Gamma, and the third Gamma value are decreased sequentially.

Wherein the first Gamma value is 3, the second Gamma value is 2.2, and the third Gamma value is 1

Wherein before the steps of obtaining at least two Gamma values of the corresponding display areas of the liquid crystal display apparatus respectively further including:

dividing the liquid crystal display apparatus into three display areas according to the conditions of the backlight of the liquid crystal display apparatus.

Wherein the Gamma values corresponding to different display areas is stored in the different registers of the liquid crystal display apparatus respectively.

Wherein the step of determining the driving voltage of the pixels in the at least two display areas according to the corresponding Gamma values respectively of the at least two display areas and the gray scale values to be displayed of the at least two display areas further including: driving by the driving voltage and turning on the pixels of the at least two display areas.

In order to solve the technology problem above, the technology approach adapted in the present application is: providing a liquid crystal display apparatus, wherein the liquid crystal display apparatus including a Gamma value acquisition module, and a driving voltage determination module;

the Gamma value acquisition module is used for obtaining the Gamma value corresponding to the at least two display areas of the liquid crystal display apparatus, wherein the Gamma value respectively corresponding to the at least two display areas is not the same, and the conditions of the backlight of the at least two display areas is not the same;

the voltage determination module is according to the different Gamma values of the at least two display areas respectively and the gray scale value of the image to be displayed in the at least two display areas to determine the pixel driving voltage of the at least two display areas.

Wherein the liquid crystal display apparatus further including a first display area, a second display area and a third display area with a descending luminance sequentially;

the Gamma value acquisition module is used for obtaining a first Gamma value corresponding to the first display area, a second Gamma value corresponding to the second display area, and a third Gamma value corresponding to the third display area; wherein the first Gamma value, the second value Gamma, and the third Gamma value are decreased sequentially.

Wherein the first Gamma value is 3, the second Gamma value is 2.2, and the third Gamma value is 1

Wherein the liquid crystal display apparatus further including a display areas dividing module, the display areas dividing module is used to divide the liquid crystal pixel area into three display areas according to the conditions of the backlight

Wherein the Gamma values corresponding to different display areas is stored in the different registers of the liquid crystal display apparatus respectively.

Wherein the liquid crystal display apparatus further including a display module, the display module is used to drive by the driving voltage and turning on the pixels of the at least two display areas.

The advantage of the present application is: distinguished from the conventional technology, in display image of the liquid crystal display apparatus of the present application, obtaining different Gamma values respectively corresponding to the different display areas with at least two conditions of the backlight, and according to the different Gamma values and the gray scale value of the image to be displayed in the at least two display areas to determine the pixel driving voltage of the at least two display areas. By the driving method in different backlight to select different Gamma values, it can effectively balance the uneven light and dark conditions of the display image caused by the different conditions of backlight, and without changing the internal structure of the liquid crystal display apparatus, easy to operate.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a schematic flow of the method of driving a liquid crystal display apparatus according to an embodiment of the present application;

FIG. 2 illustrates a schematic structure of the division of the display area according to an embodiment of the present application;

FIG. 3 illustrates a figure of the different Gamma values corresponding to the luminance according to an embodiment of the present application;

FIG. 4 illustrates a schematic flow of the method of driving a liquid crystal display apparatus according to another embodiment of the present application;

FIG. 5 illustrates a schematic structure of a liquid crystal display apparatus according to one embodiment of the present application;

FIG. 6 illustrates a schematic structure of a liquid crystal display apparatus according to another embodiment of the present application; and

FIG. 7 illustrates a schematic structure of a liquid crystal display apparatus according to the other embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

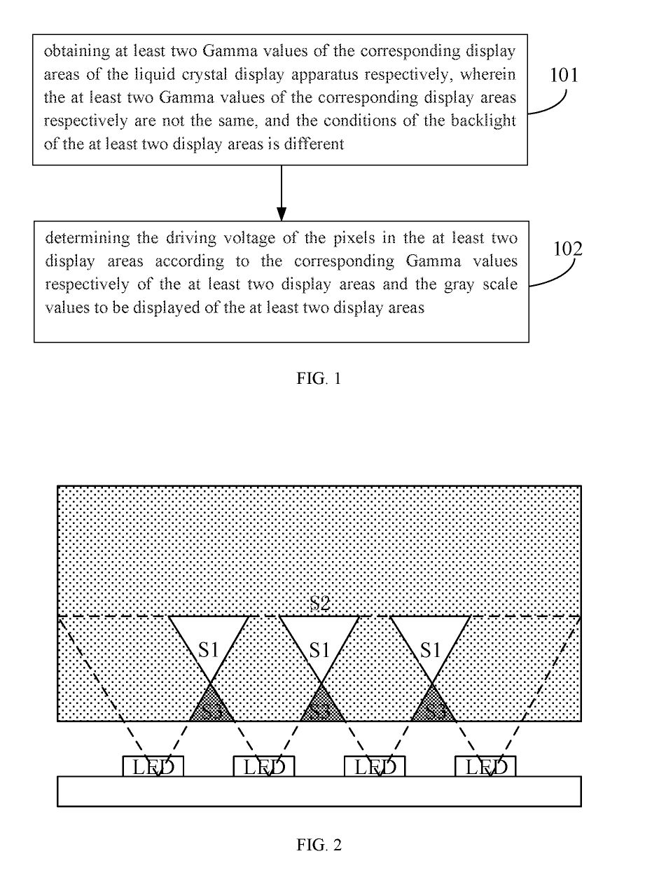

Referring to FIG. 1, FIG. 1 illustrates a schematic flow of the method of driving a liquid crystal display apparatus according to an embodiment of the present application. As illustrated in FIG. 1, the driving method of the embodiment including the following steps:

101: obtaining at least two Gamma values of the corresponding display areas of the liquid crystal display apparatus respectively, wherein the at least two Gamma values of the corresponding display areas respectively are not the same.

Wherein the liquid crystal display apparatus including at least one liquid crystal display device of smart phones, tablet PCs, PC, LCD TV and so on.

Because of the different conditions of backlight in the disposed area of the pixel, when corresponding to the liquid crystal display apparatus, if adapting same driving voltage, the liquid crystal display apparatus will appear images with uneven luminance, in order to overcome the above problems, i.e., in order to ensure the overall uniform luminance image of the liquid crystal display apparatus, the pixel region is divided into at least two different display areas according to the backlight of the liquid crystal display apparatus, such as three, four or more display areas, and is not limited here.

Each different display areas correspond to different Gamma values, wherein the different Gamma values are stored in the register of the liquid crystal display apparatus, such as the memory of the driving IC of the liquid crystal display apparatus.

Wherein, the Gamma values corresponding to the different display areas can be stored in the same register, or it can be stored in different registers.

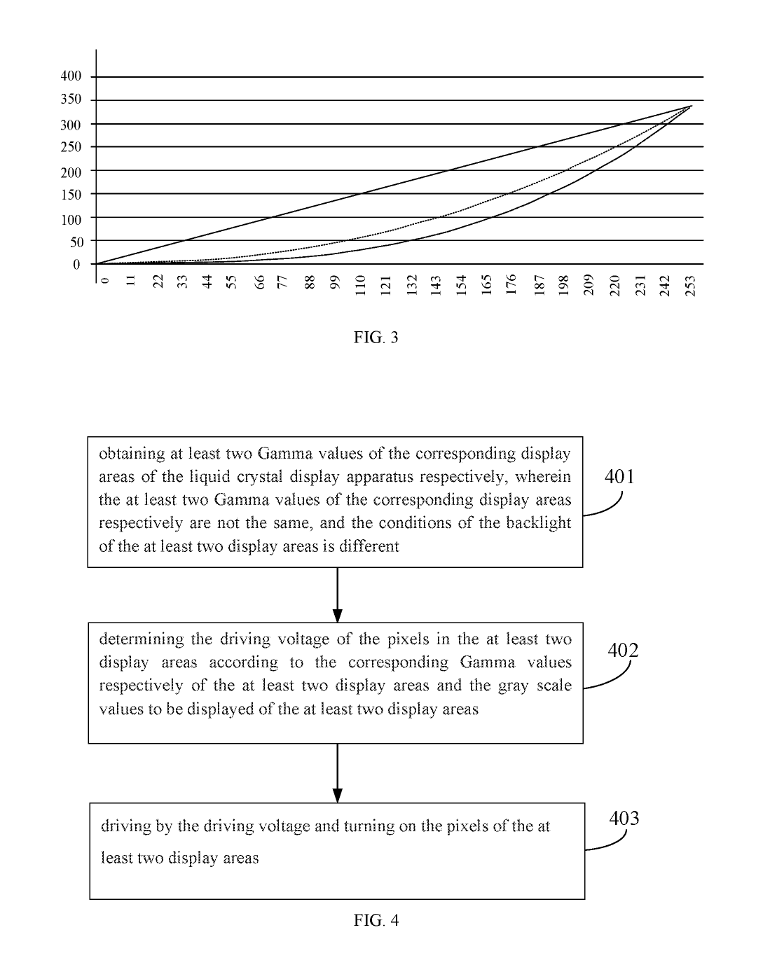

In a particular embodiment, the liquid crystal pixel area of a liquid crystal display apparatus is divided into three display areas according to the conditions of the backlight, a first display area, a second display area and a third display area, wherein the backlight luminance are decreased in order of the first display area, the second display area and the third display area, as shown in FIG. 2, FIG. 2 illustrates a schematic structure of the division of the display area according to an embodiment of the present application. When the backlight source for the liquid crystal display apparatus is selected as a LED light source, depending on the backlight luminance provided by the LED lights of the LED light source, the display area of the liquid crystal display apparatus is divided with a descending luminance in order of a S1 area, a S2 area and a S3 area. Wherein, the S1 are is corresponding to the first display area, the S2 area is corresponding to the second display area, the S3 area is corresponding to the third display area.

Wherein the first display area is corresponding to a first Gamma value, the second display area is corresponding to a second Gamma value, the third display area is corresponding a third Gamma value. Because the larger the Gamma value is, the Gamma curve corresponding to each of the Gamma value is closer to the X axis of the gray scale value, that is, the lower the overall of the display luminance, therefore, the first Gamma value, the second value Gamma, and the third Gamma value are decreased sequentially. In a general embodiment, in order to make the overall display luminance normally, uniformly, the second Gamma value that is in the middle is generally selected as the reference value, such as 2.2. The other values of the first Gamma value and the third Gamma value are set to values greater than the reference value and less than the reference value respectively. In the present embodiment, the first Gamma value is 3, the second Gamma value is 2.2, and the third Gamma value is 1, the Gamma curve of the three specific Gamma values corresponding to is shown in FIG. 3. As illustrated in FIG. 3, the horizontal axis represents to the gray scale value of the display image, the vertical axis represents to the luminance of the display image, the three Gamma curves from the bottom to top closed to the horizontal axis is corresponding to the first Gamma value, the second value and the third Gamma value respectively.

It should be noted that, the three Gamma values described above are only illustrative embodiments, and not to be a limitation to the Gamma values when divided the display area into three different areas, in other embodiments, other Gamma values can be set according to the actual value, and not limited here.

When the liquid crystal display apparatus to display image, the corresponding Gamma values respectively of the at least two display areas divided previously is obtained from its register.

102: According to the corresponding Gamma values respectively of the at least two display areas and the gray scale values to be displayed of the at least two display areas, to determine the driving voltage of the pixels in the at least two display areas.

After determining the corresponding Gamma values respectively of the at least two display areas of the liquid crystal display apparatus, since the Gamma value of the Gamma curve is one to one relationship, by just determining the gray scale values to be displayed corresponding to the horizontal axis of the Gamma curve of the at least two display areas, the luminance of the display image to be displayed of the at least two display areas can be determined. Also, because the luminance of the display image is determined by the driving voltage of the pixels of at least two display area, therefore, after determining the corresponding Gamma value respectively of the at least two display areas of the liquid crystal display apparatus, the driving voltage of the pixels in the at least two display areas can be determined according to the gray scale value of the image to be displayed in the at least two display areas.

In another embodiment, as illustrated in FIG. 4, after the steps of determining the driving voltage of the pixels in the at least two display areas, the method of driving the liquid crystal display apparatus of the present embodiment further including step 403: drive and turn on the pixels of the at least two display areas by the driving voltage.

Driving by the driving voltage and turning on the pixels of the at least two display areas. The luminance difference forms by the driving voltage can well balance the luminance difference raised due to different conditions of the backlight, and uniform the luminance of the entire image of the liquid crystal display apparatus.

For example, in conjunction with FIG. 2 and FIG. 3, the luminance of the first display area is greater than the luminance of the third display area, since the Gamma value corresponding to the first display area is larger than the Gamma value corresponding to the third display area, i.e., in the same gray scale value, the display luminance corresponding to the first display area is lower than the display luminance corresponding to the third display area, luminance difference by the different Gamma value can balance the luminance difference raised due to different conditions of the backlight, and uniform the luminance of the entire image of the liquid crystal display apparatus.

Distinguished from the conventional technology, in display image of the liquid crystal display apparatus of the present application, obtaining different Gamma values respectively corresponding to the different display areas with at least two conditions of the backlight, and according to the different Gamma values and the gray scale value of the image to be displayed in the at least two display areas to determine the pixel driving voltage of the at least two display areas. By the driving method in different backlight to select different Gamma values, it can effectively balance the uneven light and dark conditions of the display image caused by the different conditions of backlight, and without changing the internal structure of the liquid crystal display apparatus, easy to operate.

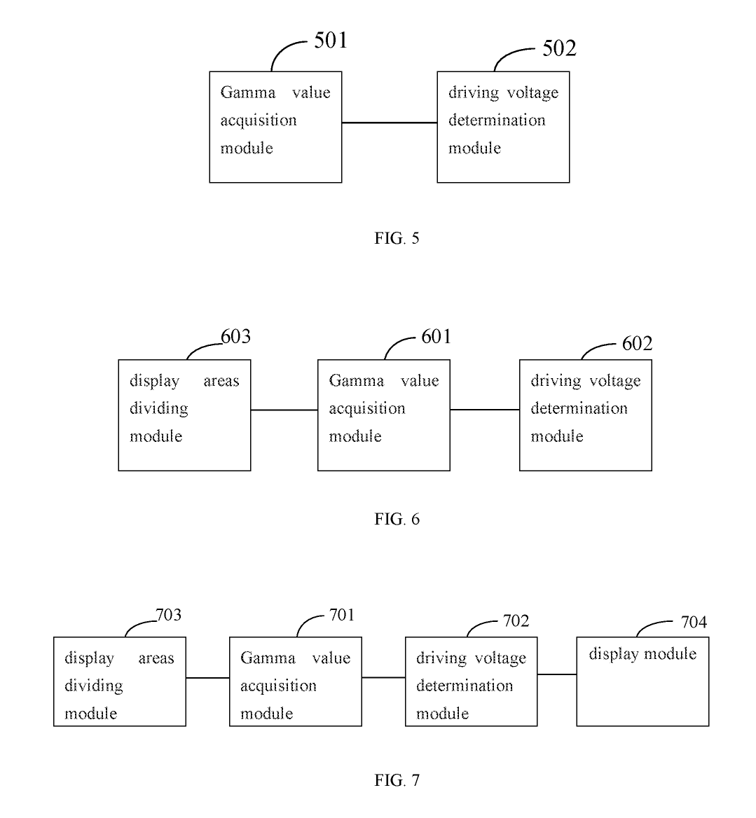

Referring to FIG. 5, FIG. 5 illustrates a schematic structure of a liquid crystal display apparatus according to one embodiment of the present application. As shown in FIG. 5, the liquid crystal display apparatus of the present embodiment including at least one liquid crystal display apparatus device such as smart phones, tablet PCs, PCs, LCD TVs and etc. It specific includes a Gamma value acquisition module 501, and a driving voltage determination module 502.

The Gamma value acquisition module 501 is used for obtaining the Gamma value corresponding to the at least two display areas of the liquid crystal display apparatus, wherein the Gamma value respectively corresponding to the at least two display areas is not the same, and the conditions of the backlight of the at least two display areas is not the same The voltage determination module 502 is according to the different Gamma values of the at least two display areas respectively and the gray scale value of the image to be displayed in the at least two display areas to determine the pixel driving voltage of the at least two display areas.

Specifically, in order to clearly illustrated the operation process of the liquid crystal display apparatus, further referring to FIG. 6, FIG. 6 illustrates a schematic structure of a liquid crystal display apparatus according to another embodiment of the present application. In order to ensure the uniform the luminance of the entire image of the liquid crystal display apparatus, the liquid crystal display apparatus further includes a display areas dividing module 603, the areas dividing module 603 can divide the pixel area into at least two distinct display areas according to the conditions of the backlight, e.g., three, four or more display areas is not limited by this.

Each different display areas correspond to different Gamma values, wherein the different Gamma values are stored in the register of the liquid crystal display apparatus, such as the memory of the driving IC of the liquid crystal display apparatus.

Wherein, the Gamma values corresponding to the different display areas can be stored in the same register, or it can be stored in different registers.

In a particular embodiment, the display areas dividing module 603 divides the liquid crystal pixel area into three display areas according to the conditions of the backlight, a first display area, a second display area and a third display area, wherein the backlight luminance are decreased in order of the first display area, the second display area and the third display area.

Wherein the first display area is corresponding to a first Gamma value, the second display area is corresponding to a second Gamma value, the third display area is corresponding a third Gamma value. Because the larger the Gamma value is, the Gamma curve corresponding to each of the Gamma value is closer to the X axis of the gray scale value, that is, the lower the overall of the display luminance, therefore, the first Gamma value, the second value Gamma, and the third Gamma value are decreased sequentially. In a general embodiment, in order to make the overall display luminance normally, uniformly, the second Gamma value that is in the middle is generally selected as the reference value, such as 2.2. The other values of the first Gamma value and the third Gamma value are set to values greater than the reference value and less than the reference value respectively. In the present embodiment, the first Gamma value is 3, the second Gamma value is 2.2, and the third Gamma value is 1.

It should be noted that, the three Gamma values described above are only illustrative embodiments, and not to be a limitation to the Gamma values when divided the display area into three different areas, in other embodiments, other Gamma values can be set according to the actual value, and not limited here.

When the liquid crystal display apparatus to display image the Gamma value acquisition module 601 is obtaining the corresponding Gamma values respectively of the at least two display areas divided previously from its register.

Since the Gamma value of the Gamma curve is one to one relationship, by just determining the gray scale values to be displayed corresponding to the horizontal axis of the Gamma curve of the at least two display areas, the luminance of the display image to be displayed of the at least two display areas can be determined. Also, because the luminance of the display image is determined by the driving voltage of the pixels of at least two display area, therefore, after determining the corresponding Gamma value respectively of the at least two display areas of the liquid crystal display apparatus by the Gamma value acquisition module 601, the driving voltage of the pixels in the at least two display areas can be determined by the voltage determination module 602 according to the gray scale value of the image to be displayed in the at least two display areas.

Further referring to FIG. 7, the liquid crystal display apparatus further includes a display module 704, the display module 704 is used to turn on the pixels of the at least two display areas by the driving voltage.

Driving by the driving voltage and turning on the pixels of the at least two display areas. The luminance difference forms by the driving voltage can well balance the luminance difference raised due to different conditions of the backlight, and uniform the luminance of the entire image of the liquid crystal display apparatus.

For example, the luminance of the first display area is greater than the luminance of the third display area, since the Gamma value corresponding to the first display area is larger than the Gamma value corresponding to the third display area, i.e., in the same gray scale value, the display luminance corresponding to the first display area is lower than the display luminance corresponding to the third display area, luminance difference by the different Gamma value can balance the luminance difference raised due to different conditions of the backlight, and uniform the luminance of the entire image of the liquid crystal display apparatus.

Distinguished from the conventional technology, in display image of the liquid crystal display apparatus of the present application, obtaining different Gamma values respectively corresponding to the different display areas with at least two conditions of the backlight, and according to the different Gamma values and the gray scale value of the image to be displayed in the at least two display areas to determine the pixel driving voltage of the at least two display areas. By the driving method in different backlight to select different Gamma values, it can effectively balance the uneven light and dark conditions of the display image caused by the different conditions of backlight, and without changing the internal structure of the liquid crystal display apparatus, easy to operate.

Above are embodiments of the present application, which does not limit the scope of the present application. Any modifications, equivalent replacements or improvements within the spirit and principles of the embodiment described above should be covered by the protected scope of the invention.

What is claimed is:

1. A method of driving a liquid crystal display apparatus, comprising:
obtaining a first Gamma value corresponding to a first display area of the liquid crystal display apparatus, a second Gamma value corresponding to a second display area, and a third Gamma value corresponding to a third display area; wherein the backlight luminance corresponding to the first display area, the second display area and the third display area are decreased sequentially; the first Gamma value, the second value Gamma, and the third Gamma value are decreased sequentially;
according to the corresponding Gamma values respectively of the at least two display areas and the gray scale values to be displayed of the at least two display areas, to determine the driving voltage of the pixels in the at least two display areas; and
driving by the driving voltage and turning on the pixels of the at least two display areas.

2. The method of driving a liquid crystal display apparatus according to claim 1, wherein the first Gamma value is 3, the second Gamma value is 2.2, and the third Gamma value is 1.

3. The method of driving a liquid crystal display apparatus according to claim 1, wherein before the steps of obtaining a first Gamma value corresponding to a first display area of the liquid crystal display apparatus, a second Gamma value corresponding to a second display area, and a third Gamma value corresponding to a third display area further comprising:
dividing the liquid crystal display apparatus into three display areas according to the conditions of the backlight of the liquid crystal display apparatus.

4. The method of driving a liquid crystal display apparatus according to claim 1, wherein the Gamma values corresponding to different display areas is stored in the different registers of the liquid crystal display apparatus respectively.

5. A method of driving a liquid crystal display apparatus, comprising:
obtaining at least two Gamma values of the corresponding display areas of the liquid crystal display apparatus respectively, wherein the at least two Gamma values of the corresponding display areas respectively are not the same, and the conditions of the backlight of the at least two display areas is different; and
determining the driving voltage of the pixels in the at least two display areas according to the corresponding Gamma values respectively of the at least two display areas and the gray scale values to be displayed of the at least two display areas.

6. The method of driving a liquid crystal display apparatus according to claim 5, wherein the liquid crystal display apparatus comprising a first display area, a second display area and a third display area with a descending luminance sequentially;
the steps of obtaining at least two Gamma values of the corresponding display areas of the liquid crystal display apparatus respectively specific comprising:
obtaining a first Gamma value corresponding to the first display area, a second Gamma value corresponding to the second display area, and a third Gamma value corresponding to the third display area; wherein the first Gamma value, the second value Gamma, and the third Gamma value are decreased sequentially.

7. The method of driving a liquid crystal display apparatus according to claim 6, wherein the first Gamma value is 3, the second Gamma value is 2.2, and the third Gamma value is 1

8. The method of driving a liquid crystal display apparatus according to claim 5, wherein before the steps of obtaining at least two Gamma values of the corresponding display areas of the liquid crystal display apparatus respectively further comprising:
dividing the liquid crystal display apparatus into three display areas according to the conditions of the backlight of the liquid crystal display apparatus.

9. The method of driving a liquid crystal display apparatus according to claim 5, wherein the Gamma values corresponding to different display areas is stored in the different registers of the liquid crystal display apparatus respectively.

10. The method of driving a liquid crystal display apparatus according to claim 5, wherein the step of determining the driving voltage of the pixels in the at least two display areas according to the corresponding Gamma values respectively of the at least two display areas and the gray scale values to be displayed of the at least two display areas further comprising:
driving by the driving voltage and turning on the pixels of the at least two display areas.

11. A liquid crystal display apparatus, wherein the liquid crystal display apparatus comprising a Gamma value acquisition module, and a driving voltage determination module;
the Gamma value acquisition module is used for obtaining the Gamma value corresponding to the at least two display areas of the liquid crystal display apparatus, wherein the Gamma value respectively corresponding to the at least two display areas is not the same, and the conditions of the backlight of the at least two display areas is not the same;
the voltage determination module is according to the different Gamma values of the at least two display areas respectively and the gray scale value of the image to be displayed in the at least two display areas to determine the pixel driving voltage of the at least two display areas.

12. The liquid crystal display apparatus according to claim 11, wherein the liquid crystal display apparatus further comprising a first display area, a second display area and a third display area with a descending luminance sequentially;
the Gamma value acquisition module is used for obtaining a first Gamma value corresponding to the first display area, a second Gamma value corresponding to the second display area, and a third Gamma value corresponding to the third display area; wherein the first Gamma value, the second value Gamma, and the third Gamma value are decreased sequentially.

13. The liquid crystal display apparatus according to claim 12, wherein the first Gamma value is 3, the second Gamma value is 2.2, and the third Gamma value is 1

14. The liquid crystal display apparatus according to claim 12, wherein the liquid crystal display apparatus further comprising a display areas dividing module, the display areas dividing module is used to divide the liquid crystal pixel area into three display areas according to the conditions of the backlight

15. The liquid crystal display apparatus according to claim 11, wherein the Gamma values corresponding to different display areas is stored in the different registers of the liquid crystal display apparatus respectively.

16. The liquid crystal display apparatus according to claim 11, wherein the liquid crystal display apparatus further comprising a display module, the display module is used to drive by the driving voltage and turning on the pixels of the at least two display areas.
